(19) United States
(12) Patent Application Publication
(10) Pub. No.: US 2018/0004609 A1
(43) Pub. Date: Jan. 4, 2018

(54) DATA RESTORATION

(71) Applicant: HEWLETT PACKARD ENTERPRISE DEVELOPMENT LP, Houston, TX (US)

(72) Inventor: Naveen Kumar Selvarajan, Bangalore (IN)

(21) Appl. No.: 15/547,414

(22) PCT Filed: Nov. 5, 2015
(86) PCT No.: PCT/US2015/059174

§ 371 Date: Jul. 28, 2017

(30) Foreign Application Priority Data
Aug. 8, 2015 (IN) 4141/CHE/2015

(51) Int. Cl. G06F 11/14

(52) U.S. Cl. CPC G06F 11/1469; G06F 11/1461; G06F 11/1451; G06F 2201/815

(57) ABSTRACT

Some examples described herein relate to data restoration. In an example, checkpoints may be defined for converting backup data stored in each of Logical Unit Numbers (LUNs) of a storage system into respective virtual data disk files. Backup data stored in each of the LUNs of the storage system may be converted into respective virtual data disk files at the defined checkpoints. The virtual data disk files with user configuration information of the storage system may be packaged into a Virtual Storage Appliance (VSA), which may include a base operating system (OS) image of the VSA. The VSA may be transferred to an external entity.

### BACKGROUND

Organizations may need to deal with a vast amount of business data these days, which could range from a few terabytes to multiple petabytes of data. Loss of data or inability to access data may impact an enterprise in various ways such us loss of potential business and lower customer satisfaction. In some scenarios, it may even be catastrophic (for example, in case of a brokerage firm).

### BRIEF DESCRIPTION OF THE DRAWINGS

For a better understanding of the solution, embodiments will now be described, purely by way of example, with reference to the accompanying drawings, in which:

FIG. 1 is a block diagram of an example system for data restoration;

FIG. 2 is a block diagram of an example system for data restoration;

FIG. 3 is a block diagram of an example system for data restoration;

FIG. 4 is a flowchart of an example method of data restoration; and

FIG. 5 is a block diagram of an example computer system for data restoration.

### DETAILED DESCRIPTION

Organizations may back up their data to a backup storage system or device. A backup storage system may include, for example, a secondary storage media such as external hard disk drives, solid-state drives (SSD), a storage array, USB flash drives, storage tapes, CDs, and DVDs. However, a backup data system may fail, get damaged or corrupted, or become inaccessible. In the event a data restore is to be performed along with existing backup windows, additional time and configuration information may be required to schedule data restore windows with existing backup windows. Either scenario is not desirable from an organization's perspective, which may prefer to get data restored as early as possible.

To address these issues, the present disclosure describes a data restoration solution. In an example, checkpoints may be defined for converting backup data stored in each of Logical Unit Numbers (LUNs) of a storage system into respective virtual data disk files. Backup data stored in each of the LUNs of the storage system may be converted into respective virtual data disk files at the defined checkpoints. The virtual data disk files with user configuration information of the storage system may be packaged into a Virtual Storage Appliance (VSA). The VSA may include a base operating system (OS) image of the VSA. The VSA may be transferred to an external entity. The VSA may be instantiated to restore the backup data stored in any of the LUNs of the storage system at a checkpoint among the defined checkpoints.

In an example, a transferred VSA may be instantiated on another system without requiring the backup system's base operating system disk. Instead, the present disclosure describes a data restoration approach where a transferred VSA's base operating system disk may be used to enable users to deploy the VSA on different devices while still allowing physical data of the original backup system to be used. The VSA may be exported to a storage system (for example, a tape drive) that may be archived and used for data restoration in the future without the need to maintain the original storage server system. Thus, for recovering backup data, the storage system that originally stored the backup data may not be required.

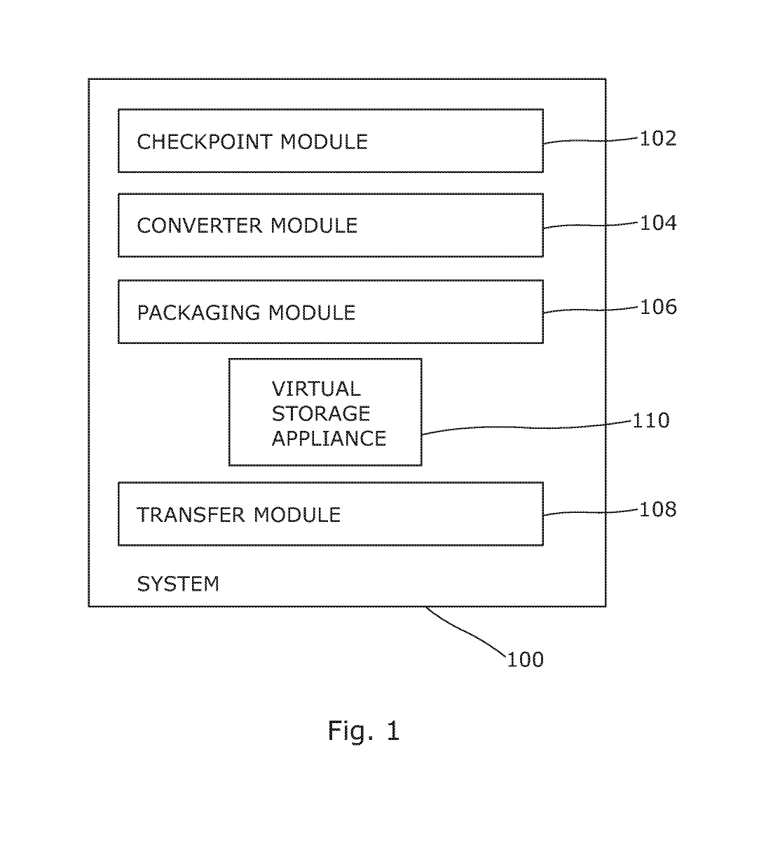

FIG. 1 is a block diagram of an example system 100 for data restoration. System 100 may represent any type of computing device capable of reading machine-executable instructions. Examples of computing device may include, without limitation, a server, a desktop computer, a notebook computer, a tablet computer, a thin client, a mobile device, a personal digital assistant (PDA), a phablet, and the like. In an instance, system 100 may be a storage server.

In an example, system 100 may be a storage device or system. System 100 may be an internal storage device, an external storage device, or a network attached storage device. Some non-limiting examples of system 100 may include a hard disk drive, a storage disc (for example, a CD-ROM, a DVD, etc.), a storage tape, a solid state drive, a USB drive, a Serial Advanced Technology Attachment (SATA) disk drive, a Fibre Channel (FC) disk drive, a Serial Attached SCSI (SAS) disk drive, a magnetic tape drive, an optical jukebox, and the like. In an example, system 100 may be a Direct Attached Storage (DAS) device, a Network Attached Storage (NAS) device, a Redundant Array of Inexpensive Disks (RAID), a data archival storage system, or a block-based device over a storage area network (SAN). In another example, system 100 may be a storage array, which may include one or more storage drives (for example, hard disk drives, solid state drives, etc.). In an example, system 100 may be a backup storage system or device that may be used to store backup data.

In an example, physical storage space provided by system 100 may be presented as a logical storage space. Such logical storage space (also referred as “logical volume”, “virtual disk”, or “storage volume”) may be identified using a “Logical Unit Number” (LUN). In another instance, physical storage space provided by system 100 may be presented as multiple logical volumes. In such case, each of the logical storage spaces may be referred to by a separate LUN. Thus, if system 100 is a physical disk, a LUN may refer to the entire physical disk, or a subset of the physical disk or disk volume. In another example, if system 100 is a storage array comprising multiple storage disk drives, physical storage space provided by the disk drives may be aggregated as a logical storage space. The aggregated logical storage space may be divided into multiple logical storage volumes, wherein each logical storage volume may be referred to by a separate LUN. LUNs, thus, may be used to identify individual or collections of physical disk devices for address by a protocol associated with a Small Computer System Interface (SCSI), Internet Small Computer System Interface (iSCSI), or Fibre Channel (FC).

System 100 may communicate with another computing or storage device (not shown) via a suitable interface or protocol such as, but not limited to, Fibre Channel, Fibre Connection (FICON), Internet Small Computer System Interface (iSCSI), HyperSCSI, and ATA over Ethernet.

In the example of FIG. 1, system 100 may include a checkpoint module 102, a converter module 104, a packaging module 106, and a transfer module 108. The term “module” may refer to a software component (machine readable instructions), a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. A module may reside on a volatile or non-volatile storage medium and configured to interact with a processor of a computing device (e.g. 100).

Checkpoint module 102 may allow definition of various checkpoints for converting backup data stored in a Logical Unit Number (LUN) of a storage system (for example, 100) into respective virtual data disk files. In other words, checkpoint module may be used to define various stages when backup data stored in a Logical Unit Number (LUN) of a storage system may be converted into a separate virtual data disk file after each stage. In an example, checkpoints may include various time periods (for example, hours, days, and months). In such case, after each time period backup data stored in a Logical Unit Number (LUN) of a storage system may be converted into a virtual data disk file. In another example, checkpoints may include the amount of unused storage space in the LUNs (for example, 15 TB, 10 TB, and 5 TB). In such case, once the amount of unused storage space in a LUN reaches a defined stage, backup data stored in the LUN may be converted into a virtual data disk file. In an instance, checkpoint module 102 may include a user interface for a user to define various checkpoints. In another instance, checkpoints may be system-defined.

Converter module 104 may convert backup data stored in a LUN of a storage system (for example, 100) into respective virtual data disk files (or virtual disk files) at the defined checkpoints. For instance, if checkpoints include various time periods, then after each time period backup data stored in a Logical Unit Number (LUN) of a storage system may be converted into a virtual data disk file. In another example, if checkpoints include amount of unused storage space in a LUN (for example, 15 TB, 10 TB, and 5 TB), then once the amount of unused storage space in the LUN of a storage system reaches a defined stage, backup data stored in the LUN may be converted into a virtual data disk file. In an example, a virtual data disk file created by conversion module may include a Virtual Machine Disk (VMDK) file. In another example, a virtual data disk file created by conversion module may include a Virtual Hard Disk (VHD) file. These are just some non-limiting examples of formats that may be used to represent a virtual data disk file.

Packaging module 106 may package virtual data disk files with user configuration information of a storage system (for example, 100) into a Virtual Storage Appliance (VSA) 110 that may include a base operating system (OS) image of the VSA. A Virtual Storage Appliance (VSA) may be defined as an appliance running on or as a virtual machine that may perform an operation related to a storage system. The operations of a VSA 110 may be isolated from other processing activities on system 100. In an example, VSA 110 may be used to restore backup data stored on an external entity (explained below).

The base operating system (OS) image of VSA 110 may include the operating system software stack to run the VSA. The VSA base disk may detect and interpret data from virtual data disks files in VSA 110.

Transfer module 108 may transfer the VSA 110 generated by packaging module to an external entity. The VSA 110 may include user configuration information of a storage system, a base operating system (OS) image of the VSA, and one or more virtual data disk files. In an example, transfer module 108 may use a file system protocol, for instance, Network File System (NFS) and Common Internet File System (CIFS) to export the VSA 110 to an external entity.

In an example, the external entity may include an external storage device. An external storage device may include, for example, an external hard disk drive, a storage disc (for example, a CD-ROM, a DVD, etc.), a storage tape, a USB drive, a Serial Advanced Technology Attachment (SATA) disk drive, a Fibre Channel (FC) disk drive, a Serial Attached SCSI (SAS) disk drive, a magnetic tape drive, an optical jukebox, and the like. Other examples of an external storage device may include a Direct Attached Storage (DAS) device, a Network Attached Storage (NAS) device, a Redundant Array of Inexpensive Disks (RAID), a data archival storage system, or a block-based device over a storage area network (SAN). In an instance, transfer module 108 may transfer the VSA 110 to a storage tape using Linear Tape File System (LTFS).

In another example, the external entity may include a cloud system. The cloud system may include a private cloud system, a public cloud system, and a hybrid cloud system. In an instance, transfer module 108 may export the VSA 110 to a cloud system via a computer network. The computer network may be a wireless or wired network. The computer network may include, for example, a Local Area Network (LAN), a Wireless Local Area Network (WAN), a Metropolitan Area Network (MAN), a Storage Area Network (SAN), a Campus Area Network (CAN), or the like. Further, the computer network may be a public network (for example, the Internet) or a private network (for example, an intranet). In an instance, the cloud system may include a pre-defined template to instantiate a transferred Virtual Storage Appliance (VSA) (for example, 110).

In an instance, transferring the virtual data disk files as a Virtual Storage Appliance (VSA) along with user configuration information of a storage system and a base operating system (OS) image of the VSA to an external entity may not remove these files from the storage system. A copy of these files and information may be maintained on the storage system.

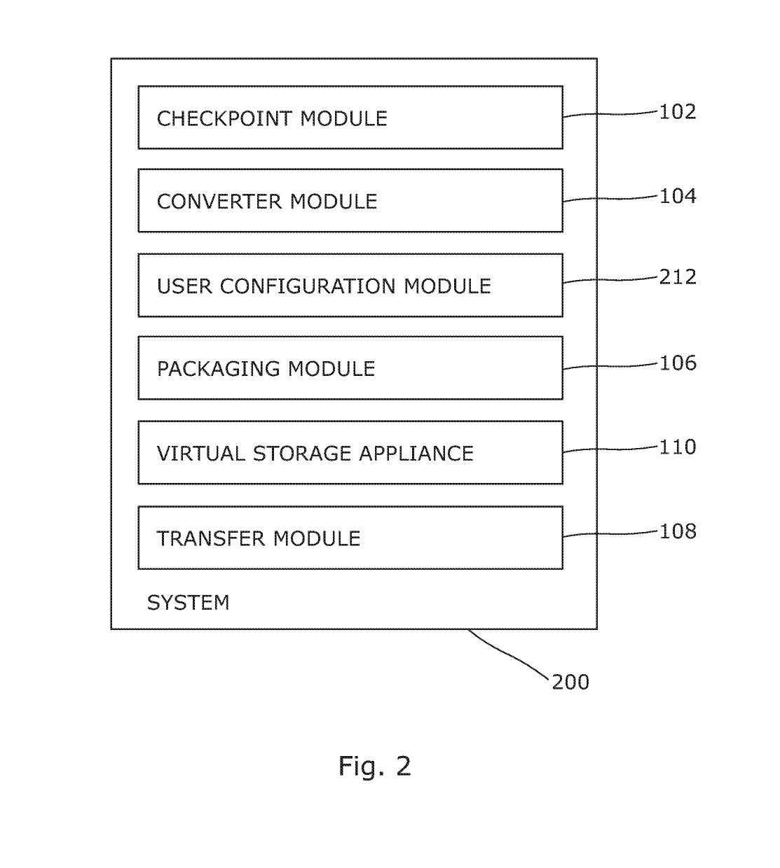

FIG. 2 is a block diagram of an example system 200 for data restoration. In an example, system 200 may be analogous to system 100 of FIG. 1, in which like reference numerals correspond to the same or similar, though perhaps not identical, components. For the sake of brevity, components or reference numerals of FIG. 2 having a same or similarly described function in FIG. 1 are not being described in connection with FIG. 2. Said components or reference numerals may be considered alike.

In an example, system 200 may include a checkpoint module 102, a converter module 104, a packaging module 106, a transfer module 108, and a user configuration module 212.

User configuration module 212 may determine user configuration information of a storage system (for example, 100 and 200). In an instance, user configuration information may include user settings and metadata regarding user data stored in a storage system (for example, 100 and 200). User configuration information may include information related to a storage target such as, for example, a Network File System (NFS), a Common Internet File System (CIFS), and a Virtual Tape Library. User configuration information may include information regarding policies and settings on a storage system such as data replication targets, user accounts, permissions, and network information.

In an instance, user configuration information may be included as part of a base operating system (OS) image of the VSA 110, which may be transferred to an external entity along with the VSA. In another instance, user configuration information may be exported as an ISO image attached to the VSA 110.

In an example, user configuration module 212 may determine the user configuration information of a storage system (for example, 100 and 200) at each of the defined checkpoints.

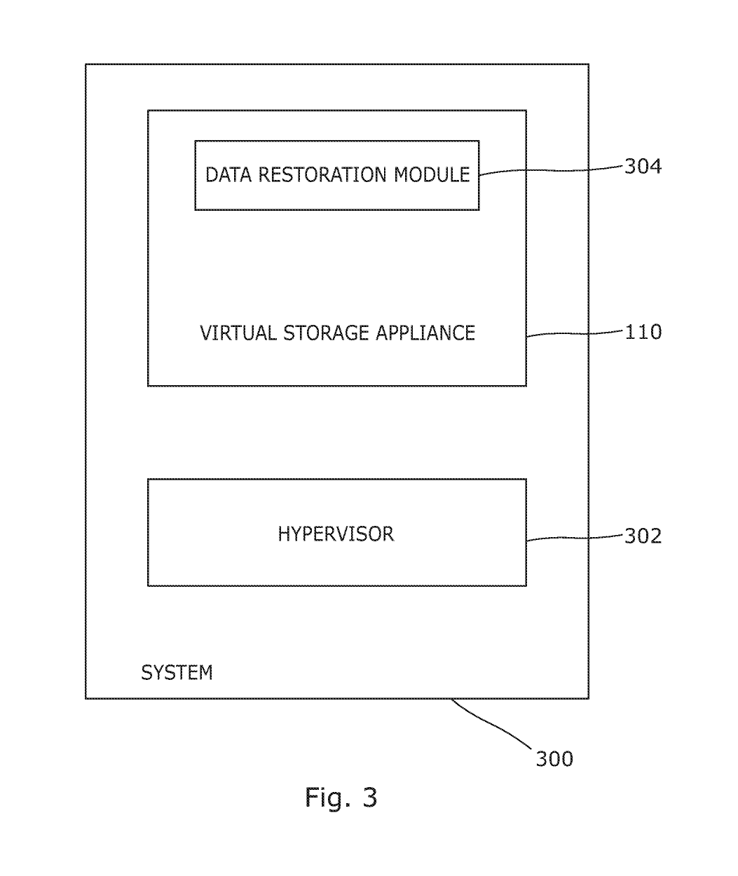

FIG. 3 is a block diagram of an example system 300 for data restoration. For the sake of brevity, components or reference numerals of FIG. 3 having a same or similarly described functions in FIG. 1 or 2 are not being described in connection with FIG. 3. Said components or reference numerals may be considered alike.

In an example, system 300 may represent any type of computing device capable of reading machine-executable instructions. Examples of computing device may include, without limitation, a server, a desktop computer, a notebook computer, a tablet computer, a thin client, a mobile device, a personal digital assistant (PDA), a phablet, and the like. In an instance, system 300 may be a storage server. In an example, physical storage space included in system 300 may be presented as a logical storage space.

In an example, system 300 may include a hypervisor 302 and a Virtual Storage Appliance 110.

Hypervisor 302 may be defined as a computer program, firmware or hardware that may create and run one or more virtual machines. A virtual machine (VM) may be an application or an operating system environment installed on hypervisor that imitates underlying hardware. System 300 on which hypervisor runs a virtual machine may be defined as a host machine. Each virtual machine may be called a guest machine. In an instance, hypervisor 302 may run a Virtual Storage Appliance (VSA) (for example, 110).

In an example, a user may instantiate a Virtual Storage Appliance (VSA) (for example, 110) received from a storage system (for example, 100 and 200) on system 300. In an instance, the VSA may include user configuration information of the source storage system (for example, 100), a base operating system (OS) image of the VSA on the source storage system (for example, 100), and one or more virtual data disk files from the source storage system (for example, 100). In an example, the VSA may include a data restoration module 304. Data restoration module 304 may use user configuration information of the source storage system (for example, 100) and one or more virtual data disk files from the source storage system (for example, 100) to restore backup data stored in a LUN of the storage system (for example, 100) at a checkpoint(s).

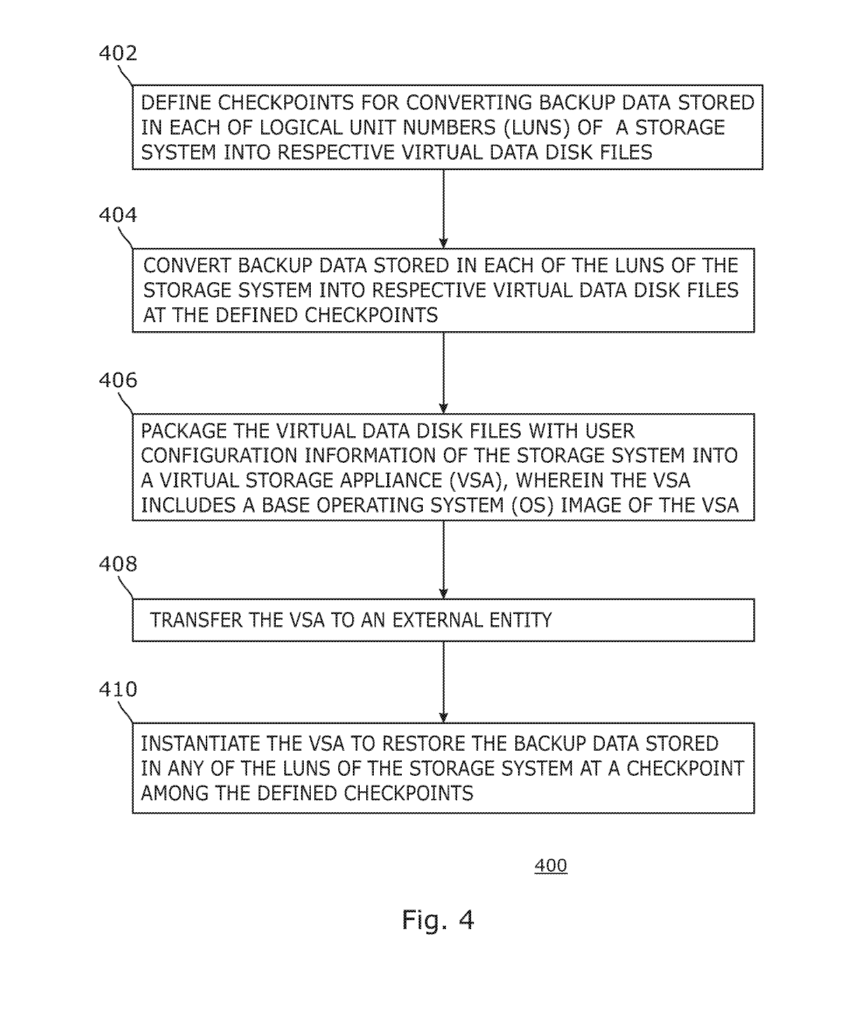

FIG. 4 is a flowchart of an example method 400 of data restoration. The method 300, which is described below, may be partially executed on a system such as system 100 and 200 of FIGS. 1 and 2 respectively, and storage system 300 of FIG. 3. However, other computing devices may be used as well. At block 402, checkpoints may be defined for converting backup data stored in each of Logical Unit Numbers (LUNs) of a storage system into respective virtual data disk files. At block 404, backup data stored in each of the LUNs of the storage system may be converted into respective virtual data disk files at the defined checkpoints. At block 406, the virtual data disk files with user configuration information of the storage system may be packaged into a Virtual Storage Appliance (VSA). The VSA may include a base operating system (OS) image of the VSA. At block 408, the VSA may be transferred to an external entity. At block 410, the VSA be instantiated to restore the backup data stored in any of the LUNs of the storage system at a checkpoint among the defined checkpoints. In an example, the checkpoint for restoring the backup data stored in each of the LUNs of the storage server may be defined.

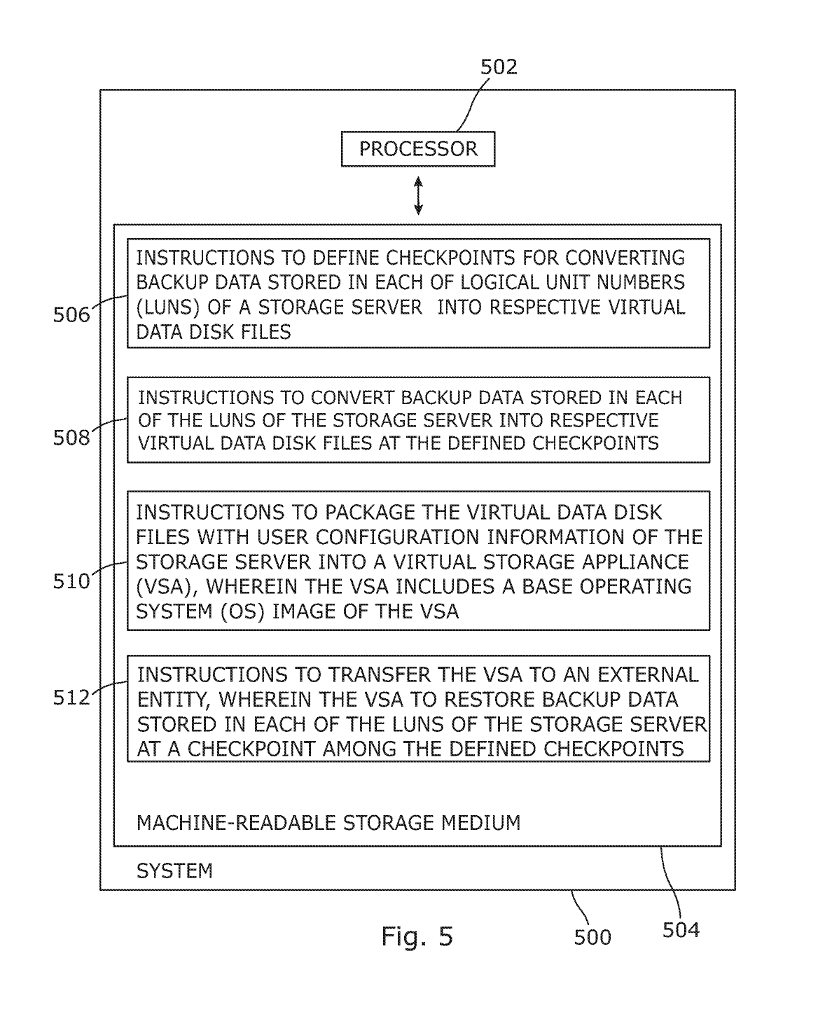

FIG. 5 is a block diagram of an example system 500 for data restoration System 500 includes a processor 502 and a machine-readable storage medium 504 communicatively coupled through a system bus. In an example, system 500 may be analogous to system 100 and 200 of FIGS. 1 and 2 respectively. Processor 502 may be any type of Central Processing Unit (CPU), microprocessor, or processing logic that interprets and executes machine-readable instructions stored in machine-readable storage medium 504. Machine-readable storage medium 504 may be a random access memory (RAM) or another type of dynamic storage device that may store information and machine-readable instructions that may be executed by processor 502. For example, machine-readable storage medium 504 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, machine-readable storage medium may be a non-transitory machine-readable medium. Machine-readable storage medium 504 may store instructions 506, 508, 510, and 512. In an example, instructions 506 may be executed by processor 502 to define checkpoints for converting backup data stored in each of Logical Unit Numbers (LUNs) of a storage server into respective virtual data disk files. Instructions 508 may be executed by processor 502 to convert backup data stored in each of the LUNs of the storage server into respective virtual data disk files at the defined checkpoints. Instructions 510 may be executed by processor 502 to package the virtual data disk files with user configuration information of the storage server into a Virtual Storage Appliance (VSA), wherein the VSA includes a base operating system (OS) image of the VSA. Instructions 512 may be executed by processor 502 to transfer the VSA to an external entity. The VSA may be used to restore backup data stored in each of the LUNs of the storage server at a checkpoint among the defined checkpoints.

In an example, machine-readable storage medium 504 may store further instructions to commit the VSA to a Write Once Read Many (WORM) state. In a WORM (Write Once Read Many) state, file data and meta-data cannot be changed. However, a file in WORM state may be readable. A file in a WORM state may be called as a WORM file. File data and meta-data cannot be changed in a WORM file. However, a WORM file may be readable.

In an example, machine-readable storage medium 504 may store further instructions to mark virtual data disk files as read only. In other words, virtual data disk files may not be modifiable.

For the purpose of simplicity of explanation, the example method of FIG. 4 is shown as executing serially, however it is to be understood and appreciated that the present and other examples are not limited by the illustrated order. The example systems of FIGS. 1, 2, 3 and 5, and method of FIG. 4 may be implemented in the form of a computer program product including computer-executable instructions, such as program code, which may be run on any suitable computing device in conjunction with a suitable operating system (for example, Microsoft Windows, Linux, UNIX, and the like). Embodiments within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be noted that the above-described examples of the present solution is for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution.

1. A method of data restoration, comprising:
defining checkpoints for converting backup data stored in each of Logical Unit Numbers (LUNs) of a storage system into respective virtual data disk files;
converting backup data stored in each of the LUNs of the storage system into respective virtual data disk files at the defined checkpoints;
packaging the virtual data disk files with user configuration information of the storage system into a Virtual Storage Appliance (VSA), wherein the VSA includes a base operating system (OS) image of the VSA;
transferring the VSA to an external entity; and
instantiating the VSA to restore the backup data stored in any of the LUNs of the storage system at a checkpoint among the defined checkpoints.

2. The method of claim 1, wherein the user configuration information includes user configuration at each of the defined checkpoints.

3. The method of claim 1, further comprising simultaneously backing up data to the storage system.

4. The method of claim 1, wherein the external entity is an external storage device.

5. The method of claim 1, wherein the external entity is a cloud system.

6. A system for data restoration, comprising:
a checkpoint module to define checkpoints for converting backup data stored in each of Logical Unit Numbers (LUNs) of a system into respective virtual data disk files;
a converter module to convert backup data stored in each of the LUNs of the system into respective virtual data disk files at the defined checkpoints;
a packaging module to package the virtual data disk files with user configuration information of the system into a Virtual Storage Appliance (VSA), wherein the VSA includes a base operating system (OS) image of the VSA; and
a transfer module to transfer the VSA to an external storage device, wherein the VSA is used to restore the backup data stored in any of the LUNs of the system at a checkpoint among the defined checkpoints

7. The system of claim 6, wherein the checkpoints include time periods.

8. The system of claim 6, wherein the checkpoints include amount of unused storage space in the LUNs.

9. The system of claim 6, further comprising a user configuration module to determine the user configuration information of the system.

10. The system of claim 6, wherein the external storage device is a tape drive.

11. A non-transitory machine-readable storage medium comprising instructions for data restoration, the instructions executable by a processor to:
define checkpoints for converting backup data stored in each of Logical Unit Numbers (LUNs) of a storage server into respective virtual data disk files;
convert backup data stored in each of the LUNs of the storage server into respective virtual data disk files at the defined checkpoints;
package the virtual data disk files with user configuration information of the storage server into a Virtual Storage Appliance (VSA), wherein the VSA includes a base operating system (OS) image of the VSA; and
transfer the VSA to an external entity, wherein the VSA to restore backup data stored in each of the LUNs of the storage server at a checkpoint among the defined checkpoints.

12. The storage medium of claim 11, further comprising instructions to define the checkpoint for restoring the backup data stored in each of the LUNs of the storage server.

13. The storage medium of claim 11, further comprising instructions to commit the VSA to a Write Once Read Many (WORM) state.

14. The storage medium of claim 11, further comprising instructions to determine the user configuration information of the storage server at each of the defined checkpoints.

15. The storage medium of claim 11, further comprising instructions to mark the virtual data disk files as read only.
